(19) United States
(12) Patent Application Publication
(10) Pub. No.: US 2026/0190040 A1
(43) Pub. Date: Jul. 2, 2026

(54) Power Headroom Reporting for Simultaneous Multi-Panel Transmission

(71) Applicant: Apple Inc., CUPERTINO, CA (US)

(72) Inventors: Hong HE, San Jose, CA (US); Chunxuan YE, San Diego, CA (US); Dan WU, Beijing (CN); Dawei ZHANG, Saratoga, CA (US); Jie CUI, San Jose, CA (US); Sigen YE, San Diego, CA (US); Wei ZENG, Saratoga, CA (US)

(21) Appl. No.: 18/834,403

(22) PCT Filed: Jul. 31, 2023
(86) PCT No.: PCT/CN2023/110356

§ 371 Date: Jul. 30, 2024

(51) Int. Cl. H04W 52/36; H04W 52/14

(52) U.S. Cl. CPC H04W 52/365; H04W 52/146

(57) ABSTRACT

A user equipment (UE) configured to identify a condition configured to trigger a power headroom report (PHR) for a first panel and a second panel of the UE that are configured for simultaneous multi-panel transmission (STxMP) and configure transceiver circuitry to transmit the PHR to a network using a physical uplink shared channel (PUSCH) on a transmission occasion using one of the first panel or the second panel of the UE.

### TECHNICAL FIELD

The present disclosure generally relates to wireless communication, and in particular, to power headroom reporting for simultaneous multi-panel transmission.

### BACKGROUND

Multiple input multiple output (MIMO) operations may include simultaneous multi-panel transmission (STxMP) at a user equipment (UE). This feature may provide benefits to the UE such as higher uplink throughput and reliability. For STxMP operation, the panels may share transmission power. The UE may report power headroom to a network to indicate whether there is any available transmission power at the UE. The network may consider the power headroom report when deciding whether to allocate network resources to the UE. It has been identified that there exists a need for techniques configured to support power headroom reporting for STxMP.

### SUMMARY

Some exemplary embodiments are related to an apparatus of a user equipment (UE), the apparatus having processing circuitry configured to identify a condition configured to trigger a power headroom report (PHR) for a first panel and a second panel of the UE that are configured for simultaneous multi-panel transmission (STxMP) and configure transceiver circuitry to transmit the PHR to a network using a physical uplink shared channel (PUSCH) on a transmission occasion using one of the first panel or the second panel of the UE.

Other exemplary embodiments are related to a processor configured to identify a condition configured to trigger a power headroom report (PHR) for a first panel and a second panel of the UE that are configured for simultaneous multi-panel transmission (STxMP) and configure transceiver circuitry to transmit the PHR to a network using a physical uplink shared channel (PUSCH) on a transmission occasion using one of the first panel or the second panel of the UE.

### BRIEF DESCRIPTION OF THE DRAWINGS

FIG. 1 shows an example network arrangement according to various example embodiments.

FIG. 2 shows an example user equipment (UE) according to various example embodiments.

FIG. 3 shows an example base station according to various example embodiments.

FIG. 4 shows a signaling diagram for power headroom reporting for simultaneous multi-panel transmission (STxMP) according to various example embodiments.

FIG. 5 shows an example scenario for power headroom reporting for STxMP according to various example embodiments.

FIG. 6 shows an example scenario where multiple physical uplink shared channels (PUSCHs) overlap in time across component carriers (CCs) and panels after power headroom report (PHR) is triggered.

FIG. 7 shows an example scenario according to various example embodiments.

FIG. 8 shows an example scenario according to various example embodiments.

### DETAILED DESCRIPTION

The example embodiments may be further understood with reference to the following description and the related appended drawings, wherein like elements are provided with the same reference numerals. The example embodiments relate to power headroom reporting for simultaneous multi-panel transmission (STxMP). However, reference to the term STxMP is merely provided for illustrative purposes. Different entities may refer to this type of multiple input multiple output (MIMO) enhancement by a different name.

The example embodiments are described with regard to a user equipment (UE). The example UE described herein may be equipped with multiple panels each comprising one or more antenna elements. However, reference to a UE is merely provided for illustrative purposes. The example embodiments may be utilized with any electronic component that may establish a connection to a network and is configured with the hardware, software, and/or firmware to support STxMP. Therefore, the UE as described herein is used to represent any appropriate type of electronic component.

The example embodiments are also described with regard to a fifth generation (5G) New Radio (NR) network that supports STxMP. However, reference to a 5G NR network is merely provided for illustrative purposes. The example embodiments may be utilized with any appropriate type of network that support STxMP.

The example embodiments are further described with regard to power headroom reporting. Power headroom may indicate whether a UE has available transmission power relative to a maximum transmission power. In some examples, a power headroom parameter may indicate how much relative transmission power can further be used by the UE relative to the UE's maximum transmission power capability. A positive valued parameter may indicate that a UE can transmit at a higher power or throughput than it is currently using. The UE may calculate power headroom and then send a power headroom report (PHR) to the network (e.g., base station). The network considers the PHR when deciding whether to allocate network resources to the UE.

MIMO operations may include STxMP at the UE. STxMP may provide benefits to the UE such as higher uplink throughput and reliability. For STxMP operation, the panels of the UE may share transmission power. To facilitate the implementation of STxMP, power headroom reporting should account for simultaneous multi-panel operation. Accordingly, there exists a need for techniques configured to support power headroom reporting for STxMP.

The example embodiments introduce techniques for various different aspects of power headroom reporting for STxMP. The example techniques introduced herein may be used independently from one another, in conjunction with other currently implemented power headroom reporting mechanisms, in conjunction with future implementations of power headroom reporting mechanisms or independently from other power headroom reporting mechanisms.

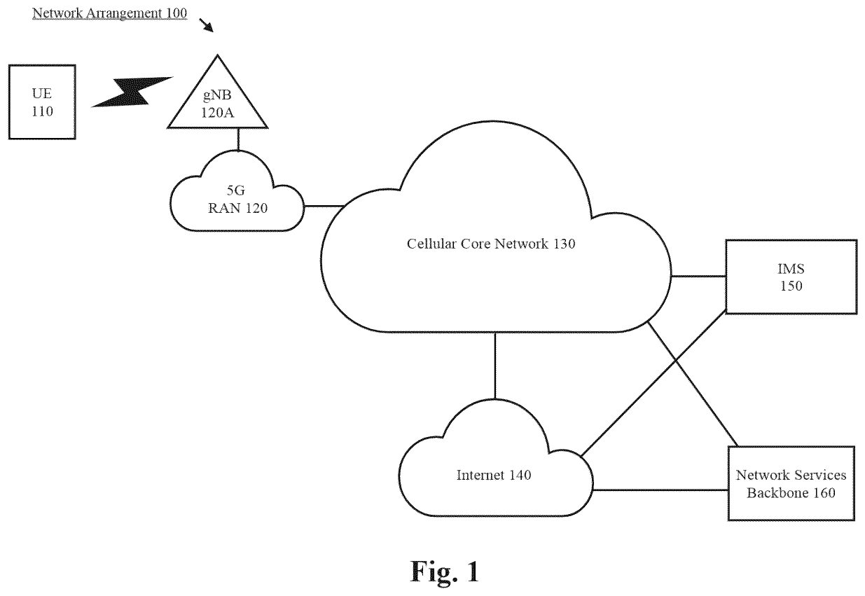

FIG. 1 shows an example network arrangement 100 according to various example embodiments. The example network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, it should be understood that the UE 110 may also communicate with other types of networks (e.g., sixth generation (6G) RAN, 5G cloud RAN, a next generate RAN (NG-RAN), a legacy cellular network, a wireless local area network (WLAN), etc.) and the UE 110 may also communicate with networks over a wired connection. Therefore, the UE 110 may have a 5G NR chipset to communicate with the NR RAN 120 and, optionally, any other appropriate type of chipset to communicate with other types of networks.

The 5G NR RAN 120 may be a portion of a cellular network that may be deployed by a network carrier (e.g., Verizon, AT&T, Sprint, T-Mobile, etc.). The 5G NR RAN 120 may include cells and base stations that are configured to send and receive traffic from UEs that are equipped with the appropriate cellular chip set. In this example, the 5G NR RAN 120 includes the gNB 120A. However, reference to a gNB is merely provided for illustrative purposes, the example embodiments may be utilized with any appropriate type of access node (e.g., Node Bs, eNodeBs, HeNBs, eNBs, gNBs, gNodeBs, macrocells, microcells, small cells, femtocells, etc.).

Those skilled in the art will understand that any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., the gNB 120A).

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

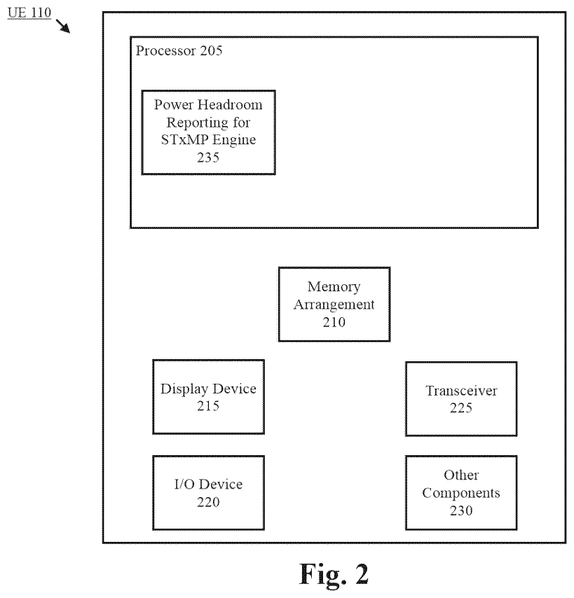

FIG. 2 shows an example UE 110 according to various example embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may, for example, multiple panels each comprising one or more antenna elements, an audio input device, an audio output device, a power supply, a data acquisition device, ports to electrically connect the UE 110 to other electronic devices, etc.

The processor 205 may be configured to execute a plurality of engines of the UE 110. For example, the engines may include a power headroom reporting for STxMP engine 235. The power headroom reporting for STxMP engine 235 may perform various operations related to the configuration and performance of power headroom reporting for STxMP operation.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

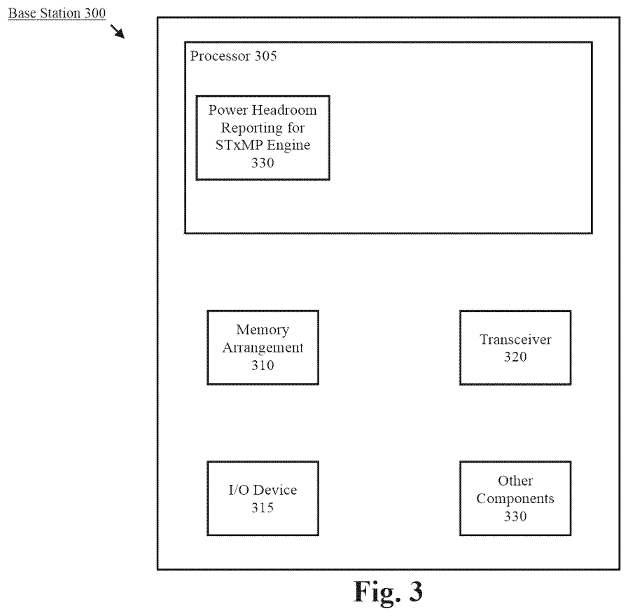

FIG. 3 shows an example base station 300 according to various example embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320 and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines of the base station 300. For example, the engines may include a power headroom reporting for STxMP engine 330. The power headroom reporting for STxMP engine 330 may perform various operations related to the configuration and performance of power headroom reporting for STxMP by the UE 110.

The above noted engine 330 being an application (e.g., a program) executed by the processor 305 is only example. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The example embodiments may be implemented in any of these or other configurations of a base station.

The memory 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UE in the network arrangement 100. The transceiver 320 may operate on a variety of different frequencies or channels (e.g., set of consecutive frequencies). The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

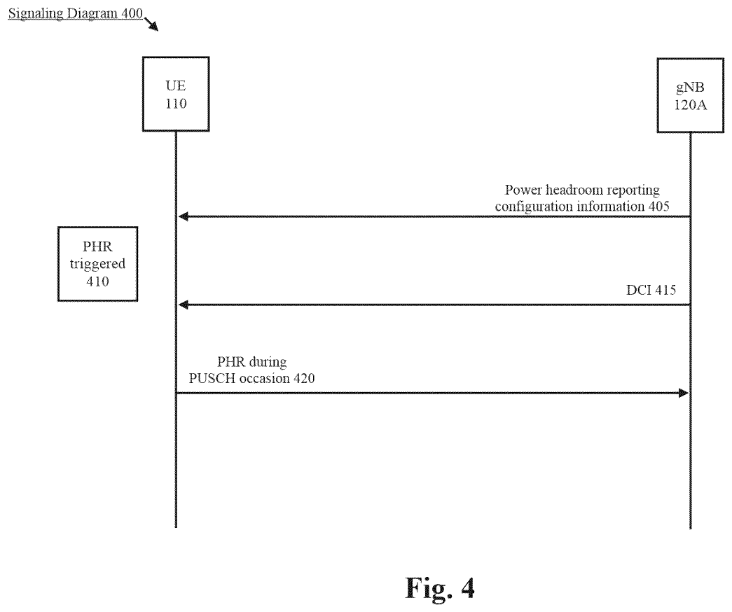

FIG. 4 shows a signaling diagram 400 for power headroom reporting for STxMP according to various example embodiments. The signaling diagram 400 is described with regard to the UE 110 and the gNB 120A of FIG. 1. The signaling diagram 400 is provided as a general overview for power headroom reporting and to provide context for the example techniques introduced herein. The example embodiments are not limited to the power headroom reporting procedure described in the signaling diagram 400 and may be utilized in any appropriate power headroom reporting procedure.

In 405, the UE 110 receives power headroom reporting configuration information. The configuration information may be provided via one or more radio resource control (RRC) messages or in any other appropriate manner.

In 410, a PHR for STxMP is triggered. The PHR may comprise a power headroom value for one or more panels of the UE. In some examples, there may be a PHR for each panel of the UE configured for STxMP. Accordingly, throughout this description, reference to the term PHR may refer to a first PHR for a first panel of the UE and a second PHR for a second panel of the UE where the first and second panels are configured to perform STxMP. As will be described in more detail below, according to some aspects, the example embodiments introduce conditions that may be configured to trigger the UE 110 to send a PHR for STxMP to the network.

In some embodiments, a prohibit timer (e.g., phr-ProhibitTimer) may be configured for each panel or shared by multiple panels. The configuration of the one or more prohibit timers may be configured by the network via RRC, hard encoded in 3GPP specifications or provided to the UE 110 in any other appropriate manner. The expiration of the prohibit timer may be a condition for triggering a PHR. In scenarios where a prohibit timer is configured per panel, the expiration of one or both timers may be a trigger condition for power headroom reporting.

Another example condition for triggering a PHR may be a change in pathloss that is more than a threshold value for at least one activated serving cell on any panel which is used as a pathloss reference since the last transmission of a PHR when a medium access control (MAC) entity of the UE 110 has uplink resources for a new transmission. The configuration of the threshold may be configured by the network via RRC, hard encoded in 3GPP specifications or provided to the UE 110 in any other appropriate manner. In some examples, at least the prohibit timer and the pathloss conditions may be used in combination as a trigger for the PHR. Using the prohibit timer and pathloss conditions in combination to trigger the PHR may have the benefit of minimizing the signaling overhead associated with power headroom reporting for STxMP.

In other embodiments, a periodic timer (e.g., phr-PeriodicTimer) may be configured for each panel or shared by multiple panels. The expiration of the periodic timer may be a condition for triggering a PHR. The configuration of the one or more periodic timers may be configured by the network via RRC, hard encoded in 3GPP specifications or provided to the UE 110 in any other appropriate manner.

In another example, a PHR report may be triggered when STxMP operation is enabled. The UE 110 may identify that STxMP operation is enabled based on one or more RRC messages received from the network or in any other appropriate manner. Another example condition for triggering a PHR report may be the activation or deactivation of a secondary cell (SCell) that supports STxMP. The UE 110 may identify activation of the SCell that supports STxMP based on one or more RRC messages received from the network or in any other appropriate manner. The example trigger conditions introduced herein may be used independently from one another, in conjunction with other currently implemented PHR trigger conditions, in conjunction with future implementations of PHR trigger conditions or independently from other PHR trigger conditions.

In 415, the UE 110 receives one or more downlink control information (DCI) on one or more component carriers (CCs). Each DCI may schedule a subsequent PUSCH transmission. It should be understood that the one or more DCI may be received before and/or after the trigger condition for the PHR occurs. In some scenarios, DCI may overlap in time with the PHR trigger conditions. It should also be understood that DCI is not required and the example embodiments may also be used with one or more configured grant (CG) PUSCH instead of or in addition to the PUSCH scheduled by DCI.

In 420, the UE 110 transmits the PHR using PUSCH on a transmission occasion to the gNB 120A. The PHR may be transmitted using a medium access control (MAC) control element (CE) or any other appropriate type of message indicated above. The network may consider the PHR when deciding whether and/or how to schedule uplink network resources for the UE 110.

At least two different types of power headroom may be supported for STxMP operation, e.g., actual power headroom and virtual power headroom. As will be described in more detail below, the example embodiments introduce techniques for the UE 110 to determine whether actual power headroom or virtual power headroom is to be used in calculating the PHR for a particular panel.

Actual power headroom may be calculated by the UE 110 based on an actual transmission on a component carrier (CC) of a panel and virtual power headroom may be calculated by the UE 110 based on a reference PUSCH format configured by the network via RRC or in another appropriate manner. Accordingly, throughout this description, the term power headroom may refer to virtual power headroom, actual power headroom or any other appropriate type of power headroom. However, reference to the terms “actual power headroom” and “virtual power headroom” are merely provided for illustrative purposes. Different entities may refer to similar concepts by a different name. Further, the specific manner in which these types of power headroom values are calculated are beyond the scope of the example embodiments.

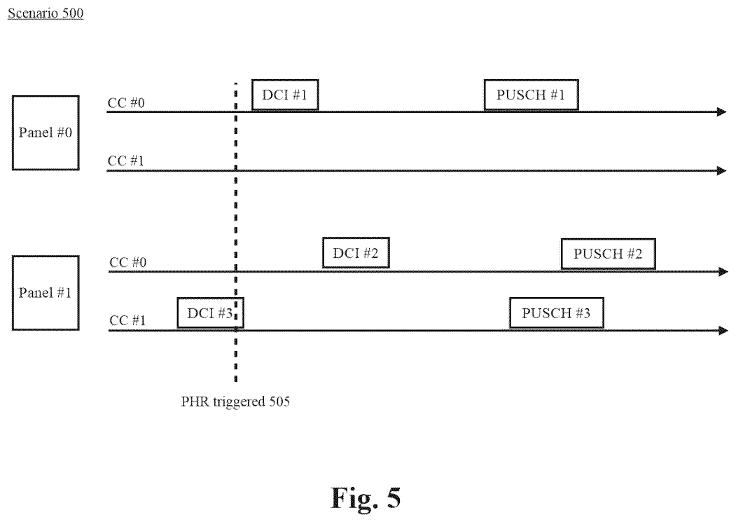

According to some aspects, the example embodiments introduce rules that may be used by the UE 110 to determine whether to use virtual power headroom or actual power headroom for the PHR. Some of the example rules are described with regard to the example scenario 500 of FIG. 5.

FIG. 5 shows an example scenario 500 for power headroom reporting for STxMP according to various example embodiments. The scenario 500 includes a first panel (panel #0) and a second panel (panel #1) of the UE 110. In this example, each panel is operating two CCs, e.g., CC #0 and CC #1.

The scenario 500 shows a timeline during which a PHR is triggered at 505. For panel #0, DCI #1 is received on CC #0 and schedules PUSCH #1. In this example, there is no PUSCH on CC #1 for panel #0. For panel #1, DCI #2 schedules PUSCH #2 on CC #0 and DCI #3 schedules PUSCH #3 on CC #1. The scheduling DCI #2 for PUSCH #2 is received after the scheduling DCI #1. The scheduling DCI #3 is received before the scheduling DCI #1. In this example, it may be assumed that PUSCH #1 is to be used to provide the PHR.

In some embodiments, the following rules may be used by the UE 110 to determine whether the UE 110 is to use actual power headroom or virtual power headroom for a given panel. These rules may be predefined and hard encoded in 3GPP specifications or provided to the UE 110 in any other appropriate manner.

The examples provided below assume a PUSCH transmission occasion i is to be used to convey the PHR for multiple panels. In one example, the UE 110 may be configured to compute virtual power headroom using the PUSCH reference format when the UE 110 does not transmit PUSCH in transmission occasion i for carrier f of panel k. Instead of or in addition to the rule described above, the UE 110 may be configured to compute virtual power headroom using the PUSCH reference format when the scheduling DCI of an actual PUSCH transmission on carrier f of panel k comes after the first DCI that schedules PUSCH transmission during PUSCH occasion i. For other scenarios where PUSCH is transmitted in PUSCH occasion i on carrier f of panel k, an actual PHR is computed based on the actual PUSCH transmission. The term PUSCH occasion may refer to a transmission occasion during which PUSCH may be transmitted.

To provide an example within the context of scenario 500, assume that PUSCH #1 is to be used to send the PHR for at least panels #0 and #1. Using the rules described above, the UE 110 is to calculate a virtual power headroom for CC #1 of panel #0 because the UE 110 does not transmit PUSCH for this carrier. The UE 110 may also calculate virtual power headroom for CC #0 of panel #1 because DCI #2 schedules an actual PUSCH transmission and comes after DCI #1 which schedules PUSCH #1 which is to be used for the PHR.

Continuing with the above example, the UE 110 is to calculate actual power headroom for CC #0 of panel #0 because it does not meet any of the example virtual power headroom rules described above. For CC #1 of panel #1, the DCI #3 is received prior to DCI #1 and thus, the UE 110 is to calculate actual power headroom for CC #1 of panel #1 because it does not meet any of the example virtual power headroom rules described above.

The example rules introduced herein may be used independently from one another, in conjunction with other currently implemented rules for power headroom reporting, in conjunction with future implementations of rules for power headroom reporting or independently from other rules for power headroom reporting.

In another approach, the network may use RRC signaling to indicate whether a virtual or actual power headroom is to be reported. For instance, when a PHR is transmitted on a PUSCH occasion i of panel k, the network may use RRC to configure whether the UE 110 is to report actual power headroom or virtual power headroom for the CCs of panel j where j≠k. In this example, the RRC signaling is for the CCs of the other panel, for the other CC of panel k legacy rules may be used to determine whether to transmit actual or virtual power headroom.

When RRC signaling indicates that virtual power headroom is to be reported for a CC of panel j then virtual power headroom is to be reported. For instance, within the context of the scenario 500, the network may indicate that one or both of CC #0 and CC #1 of panel #1 is to report virtual PHR.

When actual power headroom is configured by RRC signaling, virtual power headroom may still be reported in certain scenarios. For instance, virtual power headroom may be reported when the UE 110 does not transmit PUSCH in transmission occasion i for the CC of panel j. In another example, when actual power headroom is configured by the network, virtual power headroom may be reported when the scheduling DCI of an actual PUSCH transmission the CC of panel j comes after the first DCI that schedules PUSCH transmission during PUSCH occasion i. Thus, despite RRC signaling indicating that actual PHR is to be provided, there may be scenarios where the CCs of the other panel report virtual PHR. The example embodiments introduce a UE capability for STxMP operation to indicate whether the UE 110 supports virtual and/or actual power headroom configuration for the other panel (e.g., panel j) via RRC signaling.

According to some aspects, a scenario may occur where there are PUSCHs that overlap in time across CCs and panels after PHR is triggered. The example embodiments introduce techniques for selecting the PUSCH that is to be used for the PHR when this type of scenario occurs.

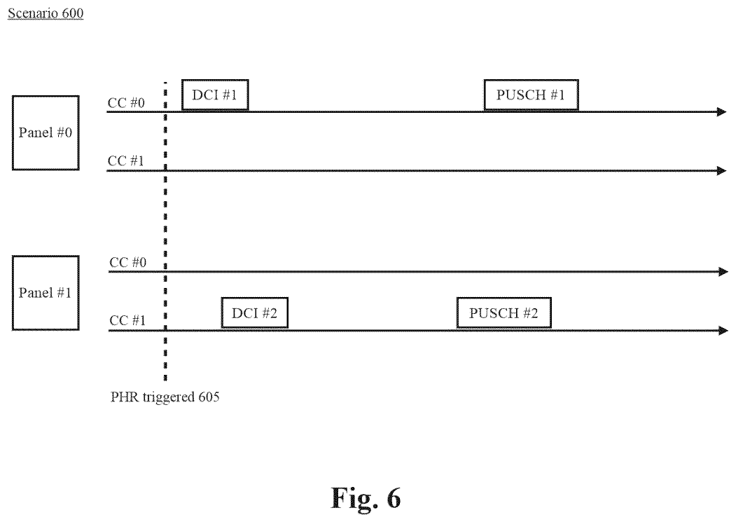

FIG. 6 shows an example scenario 600 where multiple PUSCHs overlap in time across CCs and panels after PHR is triggered. The scenario 600 includes a first panel (panel #0) and a second panel (panel #1) of the UE 110. In this example, each panel is operating two CCs, e.g., CC #0 and CC #1.

The scenario 600 shows a timeline during which PHR is triggered at 605. For panel #0, DCI #1 is received on CC #0 and schedules PUSCH #1. There is no PUSCH on CC #1 for panel #0. For panel #1, DCI #2 is received on CC #1 which schedules PUSCH #2. There is no PUSCH on CC #0 for panel #1.

In some embodiments, the earliest PUSCH transmission across CCs and panels may be selected to carry the triggered PHR. To provide an example within the context of the example scenario 600, PUSCH #2 may be selected for the PHR since PUSCH #2 is scheduled to occur prior to PUSCH #1.

In other embodiments, the PUSCH transmission scheduled by the first DCI after PHR triggering is selected to carry the triggered PHR. To provide an example within the context of the example scenario 600, PUSCH #1 may be selected for the PHR since DCI #1 is received prior to DCI #2.

According to some aspects, the example embodiments introduce a technique for a scenario in which there is more than one PUSCH in a slot of a CC of a panel k where PHR is calculated and if that slot fully overlaps with the slot of the uplink transmission of a same CC or a different CC of panel j (where j≠k) carrying the PHR. In this type of scenario, the earliest PUSCH in a slot of a same CC of a panel k may be reported.

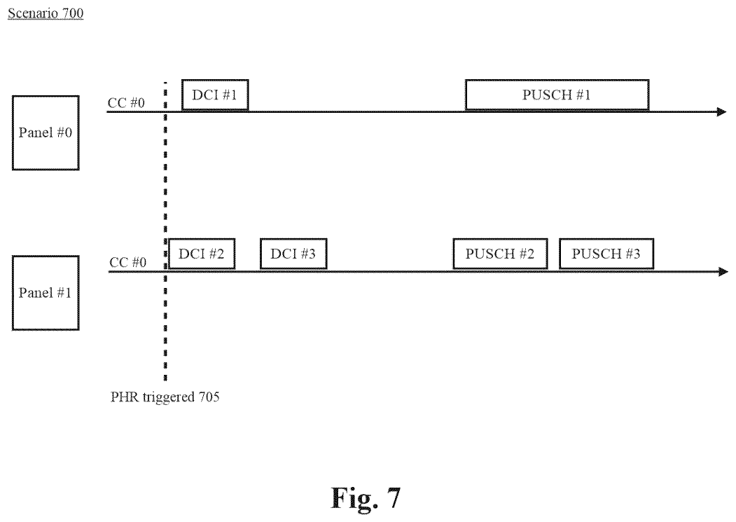

An example of this scenario is shown in FIG. 7 where scenario 700 includes panel #0 and panel #1 of the UE 110. The scenario 700 shows a timeline during which PHR is triggered at 705. For panel #0, CC #0 includes DCI #1 which schedules PUSCH #1. For panel #1, CC #0 includes DCI #2 which schedules PUSCH #2 and DCI #3 which schedules PUSCH #3. Using the above example technique, the PUSCH #2 on panel #1 may be selected for PHR computation.

According to other aspects, the example embodiments introduce a technique for a scenario where PHR is reported on a configured grant (CG) PUSCH of a CC of a panel k. In this type of scenario, the PHR timing for the UE 110 to determine actual PHR or virtual PHR is the moment of the first uplink symbol of the configured PUSCH transmission minus an offset (T_{offset}). If the DCI is received within T_{offset}, Virtual PHR may be reported for the corresponding CC. If DCI is received outside of the T_{offset}, actual PHR may be reported for the corresponding CC. In some embodiments, T_{offset} value may be predefined and hard encoded in 3GPP specification and depend on the sub carrier spacing (SCS) of the CG PUSCH.

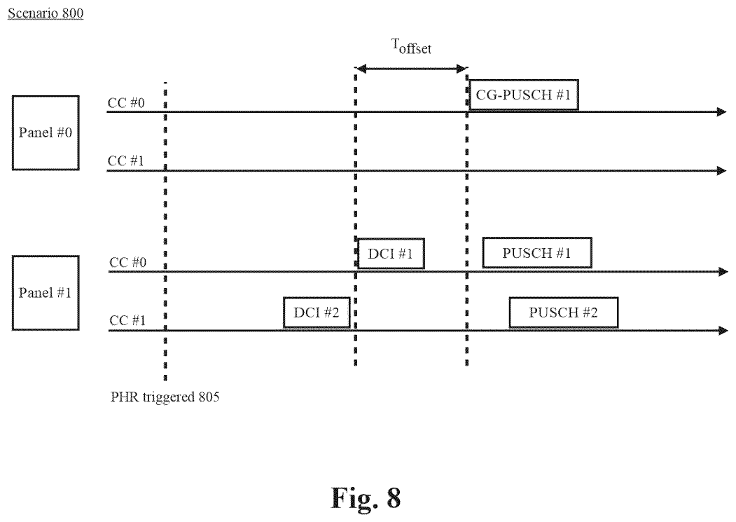

An example of this scenario is shown in FIG. 8 where scenario 800 includes panel #0 and panel #1 of the UE 110. The scenario 800 shows a timeline during which PHR is triggered at 805. For panel #0, CC #0 includes the CG-PUSCH #1 and there is no PUSCH on CC #1. For panel #1, CC #0 includes DCI #1 which schedules PUSCH #1 and CC #1 includes DCI #2 which schedules PUSCH #2. Using the above example technique, virtual PHR may be reported for CC #0 since its DCI #1 is within T_{offset} and actual PHR may be reported for CC #1 since its DCI #2 is receives outside of T_{offset}.

### Examples

In a first example, a method performed by a user equipment (UE), comprising identifying a condition configured to trigger a power headroom report (PHR) for a first panel and a second panel of the UE that are configured for simultaneous multi-panel transmission (STxMP), and configuring transceiver circuitry to transmit the PHR to a network using a physical uplink shared channel (PUSCH) on a transmission occasion using one of the first panel or the second panel of the UE.

In a second example, the method of the first example, further comprising receiving a radio resource control (RRC) message comprising parameters for at least one prohibit timer, wherein the condition configured to trigger the PHR is based on at the least one prohibit timer and a change in pathloss being more than a threshold value for at least one serving cell on any panel of the UE that is used as a pathloss reference since a transmission of a previous PHR when a medium access control (MAC) entity of the UE has uplink resources for a new transmission.

In a third example, the method of the second example, wherein a single prohibit timer is shared by the first panel and the second panel.

In a fourth example, the method of the second example, wherein the at least one prohibit timer includes a first prohibit timer corresponding to the first panel and a second prohibit timer corresponding to the second panel.

In a fifth example, the method of the first example, further comprising receiving a radio resource control (RRC) message comprising parameters for at least one periodic timer, wherein the condition configured to trigger the PHR is based on the at least one periodic timer corresponding to the first panel and the second panel.

In a sixth example, the method of the fifth example, wherein a single periodic timer is shared by the first panel and the second panel.

In a seventh example, the method of the fifth example, wherein the at least one periodic timer comprises a first periodic timer corresponding to the first panel and a second periodic timer corresponding to the second panel.

In an eighth example, the method of the first example, wherein the condition configured to trigger the PHR is when STxMP operation is enabled via radio resource control (RRC).

In a ninth example, the method of the first example, wherein the condition configured to trigger the PHR is an activation or deactivation of a secondary cell (SCell) configured with STxMP operation.

In a tenth example, the method of the first example, further comprising determining whether to use virtual power headroom report or actual power headroom report for a first component carrier (CC) of the first panel.

In an eleventh example, the method of the tenth example, wherein the processing circuitry determines to use virtual power headroom report for the first CC of the first panel when the UE does not transmit PUSCH on the PUSCH occasion for the first CC of the first panel.

In a twelfth example, the method of the tenth example, wherein the processing circuitry determines to use virtual power headroom report for the first CC of the first panel when downlink control information (DCI) of an actual PUSCH transmission on the first CC of the first panel is received after a DCI used to schedule the PUSCH occasion used for the PHR.

In a thirteenth example, the method of the tenth example, wherein the processing circuitry determines to use actual power headroom report for the first CC of the first panel when PUSCH is transmitted on the PUSCH occasion on the first CC of the first panel.

In a fourteenth example, the method of the tenth example, further comprising decoding radio resource control (RRC) signaling configured to indicate whether the UE is to use actual power headroom report or virtual power headroom report for the first CC of the first panel, wherein the PHR is transmitted to the network using the second panel.

In a fifteenth example, the method of the fourteenth example, wherein when the RRC signaling indicates that actual power headroom report is to be reported for the first CC of the first panel, virtual power headroom report is reported for the first CC of the first panel when the UE does not transmit PUSCH on the PUSCH occasion for the first CC of the first panel.

In a sixteenth example, the method of the fourteenth example, wherein when the RRC signaling indicates that actual power headroom report is to be reported for the first CC of the first panel, virtual power headroom report is reported for the first CC of the first panel when downlink control information (DCI) of an actual PUSCH transmission on the first CC of the first panel is received after a DCI used to schedule the PUSCH occasion used for the PHR.

In a seventeenth example, the method of the first example, further comprising determining whether to use a first PUSCH of a first CC of the first panel or a second PUSCH of a second CC of the second panel to carry the PHR when the first PUSCH and the second PUSCH overlap in time.

In an eighteenth example, the method of the seventeenth example, wherein the processing circuitry determines to use an earliest scheduled PUSCH of the first PUSCH and the second PUSCH to carry the PHR.

In a nineteenth example, the method of the seventeenth example, wherein downlink control information (DCI) for the first PUSCH is received after the condition configured to trigger the PHR and prior to DCI for the second PUSCH and wherein the processing circuitry determines to use the first PUSCH to carry the PHR based on the DCI for the first PUSCH being received prior to the DCI for the second PUSCH.

In a twentieth example, the method of the first example, further comprising, when a first PUSCH of a first component carrier (CC) of the first panel is used to carry the PHR and two or more PUSCHs in a slot of a second CC of the second panel overlap in time with the first PUSCH, selecting an earliest PUSCH of the two or more PUSCHs for power headroom computation for the PHR.

In a twenty first example, the method of the first example, further comprising, when the PUSCH occasion is a configured grant (CG) PUSCH on a first component carrier (CC) of the first panel, determining whether to use virtual power headroom or actual power headroom for at least one CC of the second panel based on a time offset relative to a first uplink symbol of the CG PUSCH.

In a twenty second example, the method of the twenty first example, wherein a value of the time offset is based, at least in part, on a subcarrier spacing (SCS) of the CG PUSCH.

In a twenty third example, a processor configured to perform any of the methods of the first through twenty second examples.

In a twenty fourth example, a user equipment (UE) comprising a transceiver configured to communicate with a network and a processor communicatively coupled to the transceiver and configured to perform any of the methods of the first through twenty second examples.

Those skilled in the art will understand that the above-described example embodiments may be implemented in any suitable software or hardware configuration or combination thereof. An example hardware platform for implementing the example embodiments may include, for example, an Intel ×86 based platform with compatible operating system, a Windows OS, a Mac platform and MAC OS, a mobile device having an operating system such as iOS, Android, etc. The example embodiments described above may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus of a user equipment (UE), the apparatus comprising processing circuitry configured to:
identify a condition configured to trigger a power headroom report (PHR) for a first panel and a second panel of the UE that are configured for simultaneous multi-panel transmission (STxMP); and
configure transceiver circuitry to transmit the PHR to a network using a physical uplink shared channel (PUSCH) on a transmission occasion using one of the first panel or the second panel of the UE.

2. The apparatus of claim 1, the processing circuitry further configured to:
receive a radio resource control (RRC) message comprising parameters for at least one prohibit timer, wherein the condition configured to trigger the PHR is based on at the least one prohibit timer and a change in pathloss being more than a threshold value for at least one serving cell on any panel of the UE that is used as a pathloss reference since a transmission of a previous PHR when a medium access control (MAC) entity of the UE has uplink resources for a new transmission.

3. The apparatus of claim 2, wherein a single prohibit timer is shared by the first panel and the second panel.

4. The apparatus of claim 2, wherein the at least one prohibit timer includes a first prohibit timer corresponding to the first panel and a second prohibit timer corresponding to the second panel.

5. The apparatus of claim 1, the processing circuitry further configured to:
receive a radio resource control (RRC) message comprising parameters for at least one periodic timer, wherein the condition configured to trigger the PHR is based on the at least one periodic timer corresponding to the first panel and the second panel.

6. The apparatus of claim 5, wherein a single periodic timer is shared by the first panel and the second panel.

7. The apparatus of claim 5, wherein the at least one periodic timer comprises a first periodic timer corresponding to the first panel and a second periodic timer corresponding to the second panel.

8. The apparatus of claim 1, wherein the condition configured to trigger the PHR is when STxMP operation is enabled via radio resource control (RRC).

9. The apparatus of claim 1, wherein the condition configured to trigger the PHR is an activation or deactivation of a secondary cell (SCell) configured with STxMP operation.

10. The apparatus of claim 1, wherein the processing circuitry is further configured to:
determine whether to use virtual power headroom report or actual power headroom report for a first component carrier (CC) of the first panel.

11. The apparatus of claim 10, wherein the processing circuitry determines to use virtual power headroom report for the first CC of the first panel when the UE does not transmit PUSCH on the PUSCH occasion for the first CC of the first panel.

12. The apparatus of claim 10, wherein the processing circuitry determines to use virtual power headroom report for the first CC of the first panel when downlink control information (DCI) of an actual PUSCH transmission on the first CC of the first panel is received after a DCI used to schedule the PUSCH occasion used for the PHR.

13. The apparatus of claim 10, wherein the processing circuitry determines to use actual power headroom report for the first CC of the first panel when PUSCH is transmitted on the PUSCH occasion on the first CC of the first panel.

14. The apparatus of claim 10, wherein the processing circuitry is further configured to:
decode radio resource control (RRC) signaling configured to indicate whether the UE is to use actual power headroom report or virtual power headroom report for the first CC of the first panel, wherein the PHR is transmitted to the network using the second panel.

15. The apparatus of claim 14, wherein when the RRC signaling indicates that actual power headroom report is to be reported for the first CC of the first panel, virtual power headroom report is reported for the first CC of the first panel when the UE does not transmit PUSCH on the PUSCH occasion for the first CC of the first panel.

16. The apparatus of claim 14, wherein when the RRC signaling indicates that actual power headroom report is to be reported for the first CC of the first panel, virtual power headroom report is reported for the first CC of the first panel when downlink control information (DCI) of an actual PUSCH transmission on the first CC of the first panel is received after a DCI used to schedule the PUSCH occasion used for the PHR.

17. The apparatus of claim 1, wherein the processing circuitry is further configured to:
determine whether to use a first PUSCH of a first CC of the first panel or a second PUSCH of a second CC of the second panel to carry the PHR when the first PUSCH and the second PUSCH overlap in time.

18. The apparatus of claim 17, wherein the processing circuitry determines to use an earliest scheduled PUSCH of the first PUSCH and the second PUSCH to carry the PHR.

19. The apparatus of claim 17, wherein downlink control information (DCI) for the first PUSCH is received after the condition configured to trigger the PHR and prior to DCI for the second PUSCH and wherein the processing circuitry determines to use the first PUSCH to carry the PHR based on the DCI for the first PUSCH being received prior to the DCI for the second PUSCH.

20. The apparatus of claim 1, wherein the processing circuitry is further configured to:
when a first PUSCH of a first component carrier (CC) of the first panel is used to carry the PHR and two or more PUSCHs in a slot of a second CC of the second panel overlap in time with the first PUSCH, select an earliest PUSCH of the two or more PUSCHs for power headroom computation for the PHR.
